(19) United States
(12) Patent Application Publication
(10) Pub. No.: US 2008/0300355 A1
(43) Pub. Date: Dec. 4, 2008

(54) Process For Forming Improved Fiber Reinforced Composites and Composites Therefrom

(75) Inventors: Paul Francis Kenny, Lacrosse, WI (US); Timothy Lloyd Tibor, Winona, MN (US); Dave Eastep, Winona, MN (US)

Correspondence Address: DORITY & MANNING, P.A., POST OFFICE BOX 1449, GREENVILLE, SC, 29602-1449, US

(73) Assignee: Ticona, LLC, Florence, KY (US)

(21) Appl. No.: 11/844,722

(22) Filed: Aug. 24, 2007

Related U.S. Application Data
(60) Provisional application No. 60/823,527, filed on Aug. 25, 2006.

(51) Int. Cl. C08L 67/03; C08L 69/00; C08K 3/34; C08K 3/08; C08K 3/40; B29C 47/00

(52) U.S. Cl. 524/451; 524/539; 428/401; 428/402; 524/513; 524/537; 525/420; 264/176.1

(57) ABSTRACT

The present disclosure relates to long-fiber-reinforced two-phase incompatible matrix-fiber composites which include fibers wetted completely by an incompatible mixture of thermoplastic materials. The resin mixture generally includes a polyester oligomer/polymer combination and a high polymer thermoplastic resin. The composites of the disclosure exhibit a reduced level of fiber attrition after melt-processing into articles, and show substantial improvements in mechanical properties.

### RELATED APPLICATIONS

The present application is based on and claims priority to U.S. Provisional Patent Application No. 60/823,527 filed on Aug. 25, 2006.

### FIELD OF THE INVENTION

The present invention pertains to improved long/continuous thermoplastic reinforced composites comprising long/continuous 3-20 micron-diameter fibers wetted completely by an incompatible mixture of thermoplastic materials. The invention further relates to a process for converting an incompatible thermoplastic mixture and fibers into continuous impregnated composite strands, and further downstream steps including but not limited to cutting the impregnated strands into predetermined lengths to form pellets, fusing and calendaring one or more impregnated strands to form thin tape windings, consolidating a plurality of impregnated strands to form rods, optionally fusing strands into sheets, or passing them through a consolidating/shaping die to form stocks or shaped profiles.

### BACKGROUND OF THE INVENTION

A variety of thermoplastic high polymer resins, e.g. polypropylene, ABS, PS, PA, TPU, TPE, PBT, COPE and many engineering resins have been employed to impregnate continuous fiber rovings by pultrusion. Compatibilized mixtures of polyolefin resins and other thermoplastics are known. The present invention is distinguished from short fiber-reinforced composites made by melt mixing, where formation is by impregnation of a continuous rovings, and “long” means from about 3 to 100 mm when cut into pellets, and includes continuous lengths, or long pieces of variable length over 100 mm—to meters in length.

Fiber-reinforced resin blends are known, mainly comprising a major portion of a commodity resin and minor amount of one or more property-enhancing resins. Improvements in any of the following properties are relevant for adding other property-enhancing polymers and additives: mechanical properties, e.g., flexural modulus, HDT, impact strength and thermal properties, e.g. heat distortion temperature (HDT), and tendency toward warpage.

Polyolefin (PO), e.g., polyethylene and polypropylene (PP) homo- and copolymers of ethylene or propylene and higher a-olefins, acrylates, and the like are the relatively lowest cost among the commodity thermoplastic high polymers but have relatively low heat resistance (HDT) and modest mechanical properties. Conventional approaches for incorporating property-enhancing polymers into low-cost resins, particularly PO have included the use of compatibilizers, coupling agents, and other materials that provide improved miscibility, interphase adhesion and/or coupling. Polyolefin mixtures have been proposed employing a minor amount of functional group-containing polymers, including modified polyolefins. The functional groups include carboxy, carboxylic anhydride, metal carboxylate, carboxylic ester, imino, amino, or epoxy groups, to name a few. Illustrated embodiments may be seen in U.S. Pat. No. 6,794,032 assigned to Ticona, which is incorporated herein by reference.

To-date, the primary approach for achieving improvements in composite properties according to the published literature teaches increasing compatibility. There has not heretofore been reported teaching or suggestions, particularly with respect to fiber-reinforced polymers to find further improvements in mechanical and thermal properties by selecting incompatible polymer mixtures. In this context, incompatible means that a binary mixture forms two phases having distinct phases of differing T_{g} and no detectable third alloy or co-continuous phase. Compatibility is akin to miscibility, although very few binary mixtures are truly miscible, differences in solubility parameter are associated with separate solid phases.

As it is known in the field of fiber-reinforced thermoplastics, the loss of composite mechanical properties is directly correlated with the degree of fiber attrition (i.e., breakage), as the number of fiber ends increases. It would be of industrial importance to reduce the level of fiber attrition after melt-processing into articles thereby retaining as much of the potential initial mechanical properties as possible. In respect of continuous fiber reinforced thermoplastic composites, mechanical property enhancements, and resistance to warpage are also desirable.

### SUMMARY

The present disclosure is directed to a process for impregnating continuous fiber rovings by pulling rovings at a velocity pf at least 30 feet per minute, up to 500 feet per minute through a heated impregnation zone, the impregnation occurring above the melt temperature and below the decomposition temperature of an incompatible resin mixture fed to the spaces within the impregnation zone which completely wet-out the fiber rovings. The mixture comprises 80-99 wt. % of thermoplastic polymer resin, and 1-20 wt. % of a macrocyclic polyester oligomer which is incompatible therewith. The resin mixture converts within the impregnation zone to a mixture of the thermoplastic polymer, up to 50 wt. % conversion, preferably 1-30 wt. % conversion of macrocyclic polyester oligomer to a semi-crystalline linear polyester polymer. The fiber velocity and impregnation zone temperature limit the dwell time in the zone so as to limit the conversion of macrocyclic oligomer to semicrystalline linear to a range of from 1 wt. % to 60 wt. %, preferably below 50% conversion, more preferably up to 25% conversion.

In another aspect the present disclosure is directed to a plurality of fully impregnated fiber reinforced composite strands comprising from 20 wt. % to 95 wt. % of a resin mixture and from 5 wt. % to 80 wt. % of fibers having length of at least 3 mm in the case of pellets, to continuous forms of any predetermined length. The resin mixture is incompatible and comprises a) from 1-20 wt. % of a polyester oligomer/polymer combination and 80-99 wt. % of b) a high polymer thermoplastic resin. The polyester oligomer/polymer component consists of 51-99 wt. % of amorphous macrocyclic polyester oligomer, and from 1-49 wt. % of semi-crystalline, linear polyester polymer converted from the macrocyclic oligomer. The composites according to the invention exhibit unexpected improvement in impact properties and other properties as illustrated below. Believed to be due to the incompatibility, a disproportionation of the matrix occurs, where articles formed show a polyester-rich region around the fibers and high polymer-rich region at the surface.

The fiber-reinforced composite polymer pellets and strands made in accordance with the present disclosure can be used for many different applications. For instance, in one embodiment, the composite polymer pellets or strands may be used in a molding process to form different types of polymeric articles. For instance, the composite polymer pellets or strands can be used to form any suitably shaped part, such as parts used in the automobile industry or in the aviation industry. The polymer composite can also be used to form consumer products and any other parts that may be used in industrial or manufacturing systems.

In one embodiment, for instance, the polymer composite pellets or strands may be fed into a molding process, such as an injection molding process to produce various different articles. In one embodiment, a blowing agent can be fed into the molten polymer during the molding process in order to form a foam material having a cellular structure. The foam can have, for instance, an open cell structure or a closed cell structure. Of particular advantage, use of the mixture of polymers as described above serves to minimize fiber breakage during production of the polymeric articles. Thus, molded polymeric articles made in accordance with the present disclosure can have enhanced mechanical properties. In addition, the mixture of polymers used according to the present disclosure produces a molten polymer having relatively long flow lengths. The polymer composite material, for instance, can have a flow length of greater than about 8 cm, such as greater than about 10 cm.

### BRIEF DESCRIPTION OF THE DRAWINGS

FIG. 1 is a graphical representation of automated analysis of resulting fiber lengths isolated from molded test specimen from LFRT pellets (11 mm) of a commercial PP control.

FIG. 2 is a graphical representation of measured fiber lengths of a specimen taken from a molded article molded from LFRT pellets (11 mm) according to the invention.

FIG. 3 is a cross sectional view of one embodiment of an injection molding system that may be used to mold polymeric articles in accordance with the present disclosure.

### DETAILED DESCRIPTION

Embodiments according to the disclosure include fiber-reinforced pellets of length from 3-100 mm, and continuous impregnated forms. Moldings produced from the long-fiber-reinforced pellets exhibit unexpected retention of fiber length illustrated by a fiber measurement technique described below.

One preferred embodiment of the present disclosure is a long-fiber-reinforced two-phase matrix and fiber composite which comprises 5-80 wt. % of reinforcing fibers, and 20-95 wt. % resin mixture, said resin mixture comprising from 4.0 to 70% by weight of a thermoplastic polymer, such as a polyolefin, and from 1.0 to 10% by weight of a mixture comprising 1-50 wt. % of semicrystalline, linear polyester and from 50-99% of amorphous macrocyclic polyester oligomer. Optionally and preferably the resin portion includes minor amounts of customary additives. One phase comprises the thermoplastic high polymer, and the other phase comprises the mixture of two forms of the polyester.

One particularly preferred embodiment of the invention is a long-fiber-reinforced two-phase incompatible matrix-fiber composite which comprises 40-70 wt. % fibers such as glass fibers, 30-60% of an incompatible mixture of a) a thermoplastic polymer such as polypropylene, b) linear polyester and macrocyclic polyester oligomer, where the macrocyclic oligomer makes up the major proportion of the polyester material present.

As described above, in one embodiment, the thermoplastic polymer combined with the polyester polymer and the polyester oligomer may comprise a polyolefin, such as a polyethylene or a polypropylene.

Compositions comprising polyolefin and glass fiber are known from the prior art. These compositions are described in JP-A 03126740, JP-A 03124748, GB-A 2225584, JP-A 02107664, JP-A 01087656, JP-A 01066268, JP-A 63305148, JP-B 06018929, JP-A 60104136, JP-B 61026939, JP-A 56030451, JP-A 6322266, JP-A 7053861, and JP-A 6234896, inter alia. According to the invention, the polyolefin a) may be obtained by addition polymerization of ethylene or of an α-olefin, such as propylene, using a suitable catalyst. Examples of the polyolefin a) are homopolymers of high, medium, or low density, such as polyethylene, polypropylene, polymethylpentene, and copolymers of these polymers. The homopolymers and copolymers may be straight-chain or branched. There is no restriction on branching as long as the material is capable of shaping. It is possible to use a mixture made from two or more of these polymers. These materials are mostly semicrystalline homopolymers of α-olefins and/or ethylene, or copolymers of these with one another. According to the invention, the preferred polyolefin used is polypropylene. The amounts present of the polyolefin in the long-fiber-reinforced two-phase incompatible matrix-fiber composite of the invention may moreover be from 0.1 to 20% by weight, from 20 to 24% by weight, from 25 to 30% by weight, or else from 80 to 90% by weight.

In addition to polyolefins, however, it should be understood that any suitable thermoplastic polymer may be used to construct the composite polymer. For instance, the thermoplastic polymer combined with the polyester oligomer may comprise a polyamide, such as any suitable nylon. Other thermoplastic polymers include polyimides, fluoropolymers, polyvinyl chloride, polyaromatics, and styrenic polymers.

In one embodiment, the thermoplastic polymer may comprise an acrylonitrile-butadiene-styrene (ABS) polymer. The ABS polymer can be combined with other thermoplastic polymers in addition to the polyester oligomer. For instance, in one particular embodiment, an ABS polymer can be combined with a polycarbonate. Polycarbonate/acrylonitrile-butadiene-styrene polymer mixtures, for instance, are commercially available from Bayer under the tradename “BAY BLEND”.

According to the invention, the reinforcing fiber is not restricted to a particular material. Use may be made of reinforcing fibers made from material with high melting point (softening point), such as talc, wollastonite, glass fiber, carbon fiber, metal fiber, aromatic polyamide fiber (e.g. Kevlar®), and fibers made from aromatic liquid crystalline polymer (E.g. Vectra®). According to the invention, preference is given to the use of glass fiber. The glass fibers used are usually bundles with fiber diameter of from to 8 to 25 μm and with weight of from 500 to 4400 grams per 1000 m. The fibers are preferably surface-treated with a sizing in a manner known per se. The amount of the reinforcing fiber present in the long-fiber-reinforced composite made directly by the pultrusion process may be from 5 to 16% by weight or from 50 to 75% by weight.

The fiber bundles are obtained by taking a number of fibers, treating these with an aqueous solution or aqueous emulsion of a size system, and then bundling the fibers. Preference is given to the use of wound fiber bundles which are bundled, dried, and wound onto creels (direct roving). As fiber rovings are conveyed through the impregnation zone, the ends are spliced to another bundle on a separate creel as conventionally practiced.

Macrocyclic polyester oligomers are well described in prior patents and commercially available, and are understood in the art to mean a cyclic molecule having at least one ring within its molecular structure that contains 8 or more atoms covalently connected to form the ring. As used herein, an oligomer is a molecule that contains 2 or more identifiable structural repeat units of the same or different formula.

As used herein, a macrocyclic polyester is understood to mean a macrocyclic oligomer containing structural repeat units having an ester functionality. A macrocyclic polyester oligomer is a ring of multiple molecules of one specific formula, or multiple molecules of different formulae having varying numbers of the same or different structural repeat units, and includes co-polyester or multi-polyester having two or more different structural repeat units having an ester functionality within one cyclic molecule.

The macrocyclic polyester copolyesters from macrocyclic oligoesters and cyclic esters can be a copolyester, made by transesterifying a macrocyclic oligoester with a non-macrocyclic ester in the presence of a transesterification catalyst at an elevated temperature. ε-caprolactone is a suitable non-macrocyclic ester.

Exemplary macrocyclic oligoesters used to make a macrocyclic copolyester are macrocyclic oligo(1,4-butylene terephthalate), macrocyclic oligo(ethylene terephthalate).

Preferred macrocyclic polyester oligomers include macrocyclic poly(1,4-butylene terephthalate) (PBT), poly(1,3-propylene terephthalate) (PPT), poly(1,4-cyclohexylenedimethylene terephthalate) (PCT), poly(ethylene terephthalate) (PET), and poly(1,2-ethylene 2,6-naphthalenedicarboxylate) (PEN) oligomers, and copolyester oligomers comprising two or more of the above monomer repeat units. Macrocyclic polyester oligomers are prepared by known methods. Synthesis of the preferred macrocyclic polyester oligomers may include the step of contacting at least one diol with at least one diacid chloride in the presence of at least one amine that has substantially no steric hindrance around the basic nitrogen atom such as 1,4-diazabicyclo[2.2.2]octane (DABCO). The reaction usually is conducted under substantially anhydrous conditions in a substantially water immiscible organic solvent such as methylene chloride. The temperature of the reaction typically is between about −25° and about 25° C. See, e.g., U.S. Pat. No. 5,039,783, U.S. Pat. No. 5,231,161 and U.S. Pat. No. 5,668,186 to Brunelle et al.

Other additives may also be present in the fiber reinforced composites, for example lubricants, dyes, pigments, antioxidants, heat stabilizers, light stabilizers, particulate reinforcing agents, fillers, hydrolysis stabilizers. The other additives preferably present in the reinforced composites of the invention preferably comprise at least one antioxidant and/or UV stabilizer and, where appropriate, a color masterbatch. The amount of antioxidant typically used in the long-fiber-reinforced two-phase incompatible matrix-fiber composite is suitably from 0.05 to 4.0% by weight, preferably from 0.15 to 3.0% by weight, particularly preferably from 0.2 to 2.0% by weight in the polypropylene embodiments especially.

Optional UV stabilizer present in the long-fiber-reinforced two-phase incompatible matrix-fiber composite is from 0.05 to 4.0% by weight, preferably from 0.15 to 3.0% by weight, and particularly preferably from 0.2 to 2.0% by weight.

A color masterbatch if present in the long-fiber-reinforced two-phase incompatible matrix-fiber composite is suitably employed at from 0.1 to 4.0% by weight, preferably from 0.15 to 3.0% by weight, and particularly preferably from 0.5 to 1.5% by weight.

According to a preferred process embodiment of the invention, a continuous thermoplastic impregnated roving is pultruded, where I) fiber bundles are spread as they are pulled through a flat die charged with a melt comprising an incompatible mixture of a pre-blended compound of high polymer resin, macrocyclic polyester oligomer, and additives at a temperature less than the degradation temperature of the polymers, II) the impregnated fiber bundles passes through the die within 1-2 seconds and then conducted through a shaping die, and III) the fiber bundles are cooled, and IV) the fiber bundles are cut cross-wise (perpendicular to the running direction), or are not cut, and wound up in the form of a continuous structure. The presence of catalyst, e.g. organotin, titanate, etc, recommended for use in converting the macrocyclic oligomer to a linear, semi-crystalline resin has shown little effect in raising the conversion above the specified maximum herein due to controlling the dwell time in the impregnation zone.

The surprising improvement in mechanical and thermal properties achieved in the long-fiber-reinforced two-phase incompatible matrix-fiber composites according to the invention are achieved at low conversions, e.g. as low as a few % to 5% up to 60% maximum. In light of this unexpected result, it is preferred to maintain the process conditions in the pultrusion by maintaining a minimum of 30 feet per minute roving speed, with a impregnation zone less than 5 feet in length along the machine direction. The most surprising improvement in properties was seen at a fiber content of the long-fiber-reinforced two-phase incompatible matrix-fiber composite from 50%-70%.

The impregnation of the fiber bundles with synthetic polymer, for example via pultrusion in step i) of the above process, may also take place by other suitable processes. For example, the fibers may be impregnated by a process in which the fiber bundle is saturated by passing through molten macrocyclic polyester oligomer, the fiber bundle is laid onto carrier equipment, and wherein the carrier equipment, together with the fiber bundle lying thereon, is conducted through a thermoplastic high polymer with equipment. A process of this type is described in EP 756 536.

The fiber may also be impregnated by a process in which a plastifying extruder is used and a fiber strand is conducted by way of guide apertures and preheating equipment and is wetted with molten macrocyclic polyester oligomer in an impregnating apparatus and then is introduced into the plastifying extruder in which the individual fibers are chopped and mixed with molten thermoplastic high polymer, the mixture being discharged in the form of a fiber-reinforced synthetic polymer composition capable of further processing, wherein the following steps are used:

a) passing by way of coating nozzles into the inlet of the plastifying extruder, and preferably parallel to the extruder axes and approximately tangentially, the fiber roving is wound up onto an extruder screw and around the extruder screws in an advancing direction, and also drawn into holes in the extruder barrel, whose diameter is larger, e.g., at least 2×-4× the diameter of the fiber roving and, where

b) in the inlet the right-hand coating nozzle directly applies a film of high polymer thermoplastic resin to one side of the fiber roving, while application to the second flat side takes place indirectly by pressing the fiber strand into molten macrocyclic polyester oligomer previously applied from the left-hand coating nozzle to the screw, whereupon the individual continuous rovings are subjected to impregnating or penetrating action at the extruder screws on both flat sides of the fiber roving in an inlet and impregnating section and these sides are wetted or saturated by the resin and oligomer polymers,

c) and then the fiber strand or the individual fibers thoroughly saturated or thoroughly impregnated with both polymers are passed out of the inlet and impregnation section by way of a cutting edge into the short discharge and conveying section of a reduced-diameter barrel, and thus chopped into substantially predetermined lengths.

An example of the process of this type is described in DE 198 36 787.

In one embodiment composite impregnated rovings are cut on-line by a rotary cutting die into pre-determined lengths, each comprising one or a plurality of fused impregnated fiber rovings as rod-shaped structures of length selected to be from 3 to 100 mm, preferably from 4 to 50 mm, and particularly preferably from 5 to 15 mm. The diameter of a non-consolidated rod-shaped structure, also termed a pellet, is from 1 to 10 mm, preferably from 2 to 8 mm, and particularly preferably from 3 to 6 mm. Consolidation of 10-200 individual rovings by fusing together by passing through a collection/shaping die results in rods of larger diameter, e.g. anywhere from 12-25 mm.

The invention also provides a process where the components are mixed in an extruder, and the reinforcing fiber is wetted by the melt, and the resultant material is then pelletized. The resultant pellets may be mixed with dye and/or pigment and further processed to give the component.

According to the invention, the long-fiber-reinforced two-phase incompatible matrix-fiber composite is also produced by the compounding process or by the direct process.

According to the invention, a shaped article is molded from the molten, where appropriate colored, long-fiber-reinforced polyolefin pellets in a manner known per se, such as injection molding, extrusion, blow molding, or compression with plastification.

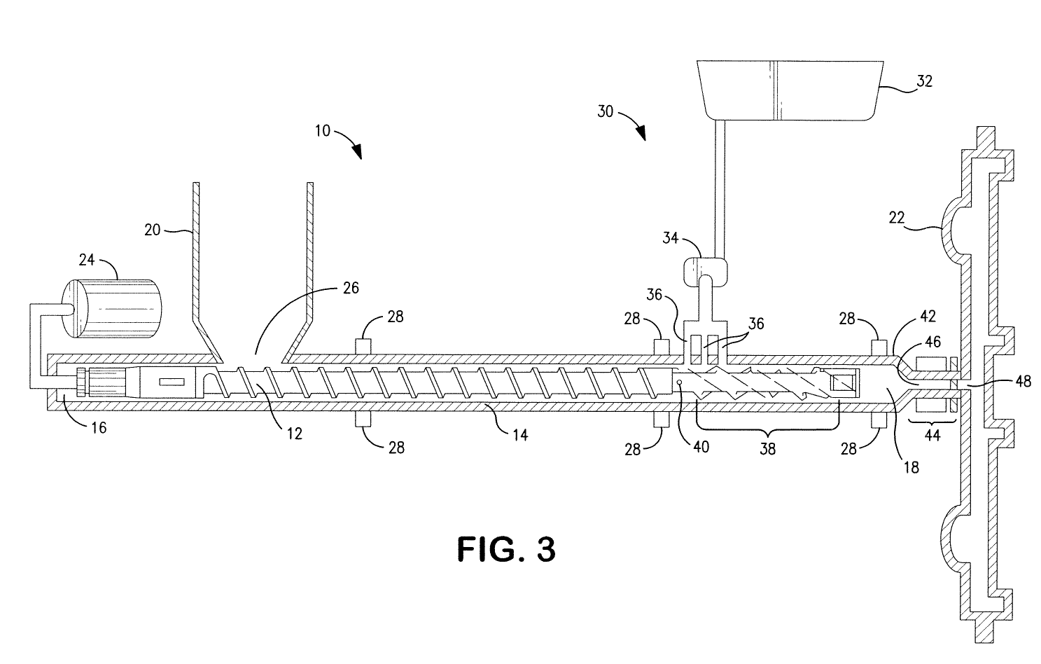

Referring to FIG. 3, for instance, one exemplary embodiment of an injection molding system generally 10 that may be used to form fiber reinforced polymer articles, such as foam articles, in accordance with the present disclosure is illustrated. As shown, the molding system 10 includes a screw 12 contained within a barrel 14. The barrel 14 includes a first end 16 and a second end 18. The barrel 14 is in communication with a hopper 20 towards the first end 16 and in communication with a molding cavity 22 towards the second end 18. The screw 12 is in operative association with a drive motor 24 that causes the screw to rotate.

During the molding process, polymer pellets containing reinforcing fibers as described above are placed into the hopper 20 and are introduced into the barrel 14 through an opening 26. Within the barrel 14, the polymer pellets are heated into a molten state. The drive motor 24 rotates the screw 12 which then, in turn, pushes the molten polymer composite material down through the barrel and into the molding cavity 22.

In order to heat the composite polymer within the barrel 14, the barrel 14 can be in communication with any suitable heating device. For instance, the barrel 14 can be heated through electrical resistance heaters, gas heaters, and the like. In one embodiment, the heating device that heats the barrel 14 can be controlled so that different zones of the barrel are at different temperatures. In this regard, the barrel 14 can be in communication with a plurality of temperature control units 28. The temperature control units, for instance, can monitor the temperature of the barrel 14 and can send information to a controller, such as a microprocessor or programmable logic unit. The controller, in turn, can control the heating device for maintaining the temperature of the barrel at the various locations within preset temperature limits. The temperature control units can work in conjunction with a controller in a closed loop manner or in an open loop manner.

The injection molding system as shown in FIG. 3 can be used to form solid polymeric articles or, alternatively, can be used to form foam products.

In order to form a cellular or foam product, the molten polymer composite material moved through the barrel 14 is combined with a blowing agent prior to being fed to the molding cavity 22. In this regard, the barrel 14 can be placed in communication with a blowing agent delivery system generally 30. As shown, the blowing agent delivery system 30 includes a blowing agent supply 32 in communication with a pressure and metering device 34. From the blowing agent supply 32, a blowing agent is fed into the barrel 14 through at least one port 36. As shown, the barrel 14 can include a plurality of ports 36. For example, in the embodiment illustrated, the blowing agent delivery system 30 includes five ports 36. Each of the injection ports 36 may, if desired, be in communication with a shutoff valve which allow the flow of the blowing agent into the extruder barrel 14 to be controlled as a function of axial position of the rotating screw 12.

In general, any suitable blowing agent may be used in the process. The blowing agent, for instance, may comprise a physical blowing agent or a chemical blowing agent. Examples of suitable blowing agents include, for instance, hydrocarbons, chlorofluorocarbons, nitrogen, carbon dioxide, helium, and the like.

In one embodiment, the blowing agent may comprise a supercritical fluid. Supercritical fluids that may be used include, for instance, carbon dioxide, nitrogen, or combinations thereof. Supercritical fluids can be introduced into the barrel and made to rapidly form a single-phase solution with the polymer composite material either by injecting the additive as a supercritical fluid, or injecting it as a gas or liquid and allowing conditions within the extruder to render it supercritical.

Combining a supercritical fluid with the composite polymer material produces a single-phase solution having a very low viscosity which advantageously allows lower temperature molding, as well as rapid filling of molds having close tolerances to form very thin molded parts, parts with very high length to thickness ratios, parts including thicker distal regions, molding carried out at low clamp force, and the like.

The supercritical fluid thus not only reduces the viscosity of the molten polymer material but also serves as a blowing agent. Using a supercritical fluid also allows for the control of the resulting properties of the foam. In particular, cellular, and particularly microcellular, articles can be produced having a void volume and/or a cell size and/or a cell density within controlled limits. All of these advantages can be obtained while using a relatively low amount of the supercritical fluid. For instance, the supercritical fluid can be present in the composite polymer material in an amount less than about 10% by weight, such as less than 5% by weight, such as less than 1% by weight, such as even less than about 0.5% by weight.

As mentioned above, the supercritical fluid allows for the injection of the composite polymer material into the mold cavity 22 at reduced temperatures. For instance, injection can take place at a molding chamber temperature of less than about 100° C., such as less than about 75° C., such as less than about 50° C., such as less than about 30° C., or even less than about 10° C.

The pressure and metering device 34 is positioned in between the blowing agent supply 32 and the at least one port 36. The pressure and metering device 34 can be used to meter the mass of the blowing agent, such as between about 0.01 lbs/hr to about 70 lbs/hr.

The particular blowing agent used and the amount of blowing agent incorporated into the composite polymer material can be selected so as to produce a foamed product with the desired cell size and void volume.

As shown in FIG. 3, the one or more ports 36 are located within or upstream from a mixing section 38 of the screw 12. The ports 36 can be located at different locations along the barrel. In one embodiment, for instance, two ports may be positioned on opposing top and bottom sides of the barrel 14. A blowing agent entering the barrel 14 through the ports 36 rapidly and evenly mixes with the molten composite polymer material into a fluid polymer stream. When the blowing agent is a supercritical fluid, a single-phase solution is produced. Having a plurality of ports that are positioned radially around the barrel 14 may enhance mixing. Further, it should be understood that many more ports 36 may be positioned along the barrel 14.

As shown in FIG. 3, the screw 12 contained within the barrel 14 includes a first portion of flights or threads that are unbroken and a second portion 38 containing broken threads. In addition, the screw 12 can include a check valve 40 that separates a first section from a second section.

In one embodiment, the ports 36 are located opposite unbroken flights along the screw 12. In this manner, as the screw rotates, each flight passes or wipes each port periodically. This wiping increases rapid mixing of the blowing agent with the composite molten polymer material. In particular, the flights rapidly open and close each port as the screw 12 rotates. The result is the distribution of relatively finely-divided, isolated regions of blowing agent in the fluid polymer material immediately upon injection and prior to any mixing.

Once the blowing agent is combined with the composite molten polymer material, the resulting mixture is then fed through the mixing section 38 contained within the barrel 14. In the mixing section, the blowing agent becomes intimately mixed with the polymer. As described above, when a supercritical fluid is present, the fluid dissolves within the polymer.

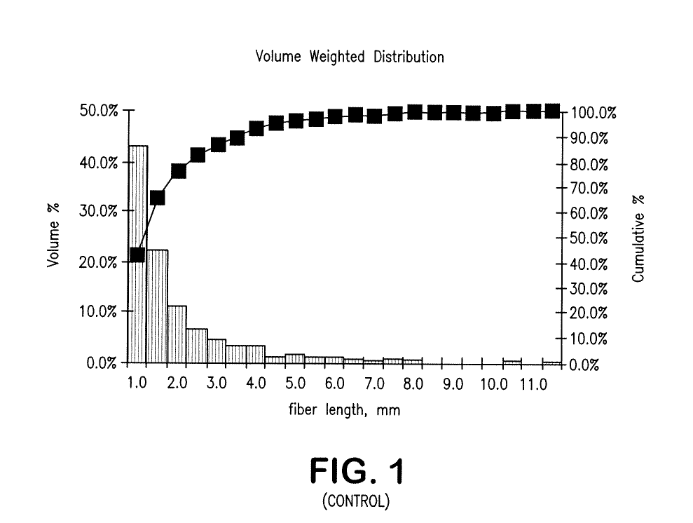

As shown in FIG. 1, the mixing section 38 includes a plurality of broken flights. More particularly, the flights include spaced apart gaps. The gaps allow better mixing of the components.

In the embodiment illustrated, the screw 12 includes less than six flights between the end of the screw and the ports 36. In particular, the screw 12 can include three to five flights, such as four flights within the mixing section.

The screw 12 can have a relatively low compression ratio. For example, the compression ratio of the screw 12 can be generally less than about 2.5:1, such as less than about 2.3:1, such as less than about 2.1:1. For instance, in one embodiment, the screw 12 can have a compression ratio of about 2:1. In other embodiments, however, the screw can have a compression ratio of greater than about 2.5:1.

After the composite molten polymer material and the blowing agent are combined together, as shown in FIG. 3, the resulting mixture enters an accumulation region 42. In the accumulation region 42, the temperature of the mixture can be carefully controlled along with other process conditions. When using a supercritical fluid as a blowing agent, a single-phase, non-nucleated solution of polymer material and blowing agent containing fibers is accumulated prior to being injected into the molding cavity 22.

From the accumulation region 42, the mixture enters a nucleator 44 constructed to include a pressure-drop nucleating pathway 46. The pressure of the polymer fiber and blowing agent mixture drops below the saturation pressure for the particular blowing agent concentration at a rate or rates facilitating nucleation. Nucleation is a process by which a homogeneous, single-phase solution of polymer material, in which is dissolved molecules of a species that is gas under ambient conditions, undergoes formations of clusters of molecules of the species that define nucleation sites from which cells grow to form a foam. During nucleation, a homogeneous, single-phase solution changes to a mixture in which sites of aggregation of at least several molecules of blowing agent are formed. Nucleation defines that transitory state when gas, in solution in a polymer melt, comes out of solution to form a suspension of bubbles within the polymer melt. When using a supercritical fluid, this transition occurs by changing the solubility of the blowing agent within the polymer. Nucleation occurs in the process through a rapid temperature and/or pressure drop.

The nucleator 44 as shown in FIG. 3 can be located at different locations within the injection molding system. In the embodiment shown in FIG. 3, for instance, the nucleator 44 defines a nozzle connecting the barrel 14 to the molding cavity 22. Thus, the nucleator defines an opening 48 that releases the blowing agent, fiber and polymer mixture into the molding cavity 22.

The opening 48 and the pathway 46 can have any size sufficient for a foam to form within the molding cavity 22. In one embodiment, the pathway 46 and the opening 48 can be adjustable in order to achieve a desired nucleation density. Further, while the pathway 46 defines a nucleating pathway, some nucleation may also take place within the molding cavity itself as pressure on the polymer material drops at a very high rate during filling of the mold.

Injection of the molten composite polymer material and blowing agent into the molding cavity 22 results in the production of a cellular material that may be classified as a foam. During injection of the material into the molding cavity 22, cell growth occurs. If desired, the molding cavity 22 can include vents to allow gas escape during injection.

In the embodiment illustrated in FIG. 3, the accumulation region 42 is shown located within the barrel 14. In an alternative embodiment, however, a separate accumulator may be provided. In this embodiment, the polymer material, fibers and blowing agent can be fed to a separate accumulator prior to being injected into the molding cavity 22.

Ultimately, through the use of the screw 12 and the process conditions, cellular fiber reinforced polymer articles can be produced having enhanced properties. If foam articles are produced, for instance, the articles can have an open cellular structure or a closed cellular structure. In general, the void volume can be from about 1% to about 50%, such as from about 3% to about 25%. For instance, in one embodiment, the void volume can be from about 5% to about 15%. The average cell size can vary depending upon different process conditions. In general, the cell size is less than about 100 microns. The cell density, on the other hand, can be at least about 10⁶ cells per cubic centimeter.

According to the present disclosure, the long-fiber-reinforced composite polymer has the shape of a rod, a strip, a ribbon, or a sheet. The shape is preferably that of a rod, obtained by using a thermoplastic to coat the surface of the fiber and therefore of the bundle composed of fiber, arranged continuously and parallel, to give a strand, and then cutting the product to the required length. The required length is between 7 and 25 mm.

According to the invention, the components other than the reinforcing fiber, may be mixed in the melt in a kneader or an extruder. The temperature is set above the melting point of the higher-melting polymer by from 5 to 100.degree. K, preferably from 10 to 60.degree.K. The mixing of the melt is complete after a period of from 30 seconds to 15 minutes, preferably from 1 to 10 minutes.

The nature of the long-fiber-reinforced two-phase incompatible matrix-fiber composite may also be such that there is substantial wetting of the fibers primarily by the polyester material, and the impregnated fiber strand in the middle of the long-fiber-reinforced two-phase incompatible matrix-fiber composite has been sheathed primarily by high polymer. An example of a process for producing a structure of this type has been described in U.S. Pat. No. 6,090,319. A long-fiber-reinforced synthetic polymer structure of this type may be produced by a process wherein after fiber impregnation by one of the processes described above, the impregnated fiber strand is drawn continuously out of the impregnation apparatus; the material intended for sheathing the two-phase incompatible matrix-fiber composite is continuously melted and, in the plastic state, is extruded through an elongate extrusion die with a completely open tubular passage in which the material intended for sheathing the two-phase incompatible matrix-fiber composite is present; and the impregnated fiber strand is continuously conveyed into and through said elongate extrusion die, while at the same time the material intended for sheathing the impregnated fiber strand is extruded; and the impregnated fiber strand is brought into contact with the molten material intended for sheathing the two-phase incompatible matrix-fiber composite and is coated thereby, giving a long-fiber-reinforced two-phase incompatible matrix-fiber composite in which there is substantial wetting of the fibers only by one of the components of high polymer and oligomer, and the impregnated fiber strand in the middle of the long-fiber-reinforced two-phase incompatible matrix-fiber composite has been sheathed by the respective other component, and components have sufficient interphase adhesion to one another; the long-fiber-reinforced two-phase incompatible matrix-fiber composite is continuously removed from the extrusion die; and the fiber bundles are cut to give the length of the structure perpendicular to their running direction, or are wound up in the form of a continuous structure.

When this process is used, a known process, preferably the pultrusion process, is used to impregnate the reinforcing fibers c) with one of components a) and b), enumerated above, which, where appropriate, may comprise one or more other additives. The resultant structure is then coated with the other component, respectively a) or b), each of which may also comprise one or more other additives.

In one embodiment, the long-fiber-reinforced two-phase incompatible matrix-fiber composite is used for producing moldings. The moldings produced from the long-fiber-reinforced two-phase incompatible matrix-fiber composite of the invention have excellent mechanical properties, in particular excellent impact strength, high heat resistance, and low deformability due to water absorption. Low warpage moreover gives the moldings improved precision of fit. The moldings may be produced from the long-fiber-reinforced two-phase incompatible matrix-fiber composites of the invention by the known processes, such as injection molding, compression molding, or blow molding.

The long-fiber-reinforced two-phase incompatible matrix-fiber composite is preferably used for producing uncolored or colored moldings subjected to high mechanical and thermal stress, for example moldings in motor vehicle construction, particularly since the level of odor emission in the interior of a vehicle is very low.

### EXAMPLES

A multistrand pultrusion line was laced with standard grade glass fiber rovings, examples of which are available from Owens Corning, or Johns Manville. The general procedure to produce test specimens is as follows:

A number of glass fiber bundles (E glass, direct roving 2400 tex were heated during continuous unwinding, and then spread by passing through a serpentine melt die. The melt die was continuously fed with a melt made from polypropylene (e.g., MFR 230/2.16 g per 10 min=48, measured to ISO 1133) from an extruder in a controlled polymer melt feed/fiber take off. The series of polypropylene-containing glass fibers (strands) were taken from the melt die and passed through a multi-u-shaped shaping die and a shaping roller, and cooled. The strands were then chopped to give a rod-shaped structure of length 11 mm, using a strand pelletizer.

The resultant pellets were injection-molded to give the test specimens described below. Impact strength and other mechanical properties were measured as described below.

### Example 1

### Polypropylene@30% Glass Fiber

Standard 30% PP—LGF (“long glass fiber”) w/o PBT oligomer (control 1) was compared to 30% LGF PP+5 wt. % of the polyester oligomer (PBT) (Example 1). Notched Impact (kJ/m²) according to ISO 179 was 18.3 for Control 1 versus 26 for Example 1.

### Example 2

### Polypropylene@40% Glass Fiber

Standard 40% PP—LGF w/o oligomer (Control 2) was compared to 40% LGF—PP+5% of the polyester oligomer (Example 2). Notched Impact (kJ/m²) per ISO 179 was 23.4 for control 2 versus 40.4 for Example 2.

### Example 3

### Polypropylene@50% Glass Fiber

Standard 50% PP—LGF w/o oligomer (Control 3) was compared to 50% LGF—PP+5% of the polyester oligomer (Example 3). Notched Impact (kJ/m²) per ISO 179 was 19.9 for Control 3 versus 45.6 for Example 3.

### Example 4

### Polypropylene@60% Glass Fiber

Standard 60% PP—LGF w/o oligomer (Control 4) was compared to 60% LGF—PP+5% of the polyester oligomer (Example 4).

Tensile Strength (MPa) per ISO 527 was 122 for Control 4 versus 142 for Example 4.

Tensile Modulus (MPa) per ISO 527 was 14381 for Control 4 versus 14026 for Example 4.

Elongation at Break (%) per ISO 527 was 1.31 for Control 4 versus 1.47 for Example 4.

Flexural Strength (MPa) per ISO 178 was 200 for Control 4 versus 259 for Example 4.

Flexural Modulus (MPa) per ISO 178 was 15027 for Control 4 versus 14772 for Example 4.

Notched Impact (kJ/m²) per ISO 179 was 23.2 for Control 4 versus 63.2 for Example 4.

As can be seen from the above data, impact strength is significantly improved according to the invention, while no significant loss or comparable mechanical properties were seen versus the conventional LFT composites. The magnitude of the improvement in impact strength increases with increasing fiber content. According to Example 3 and 4, an increase in impact strength of 87% and 272% was unexpected. In other examples made with other resins of a more polar nature, being more compatible with polyester, there was not any significant mechanical property improvement.

### Improvement in Fiber Attrition—Automated Fiber Length Measurement

Instrumentation for Automated Image Analysis System:

Prior® H101 motorized stage: 4″×3″ travel, repeatability +1 μm, with controller, joystick and holder.

QIcam® monochromatic digital firewire camera—1392×1040 pixels, 4.65 μm×4.65 μm pixel size, ½″ optical format Electronic Shutter, 12-bit, External trigger, Zoom 70XL module with detents/iris

MND44020 Nikon® Focus Mount and MSS modular support stand

150W halogen transmitted light source with backlight

ImagePro Plus® ver 6.0

Scope Pro® plug-in module

Imaging computer—Windows® XP Pro, Pentium 4-3.6 GHz processor

MS Office® 2003 Basic

Pyrex glass petri dish 100 mm×15 mm—top only; vacuum funnel and coarse filter paper.

### Method:

1. 1″ inch square sample is cut by saw from a molded test plaque in the area of interest. For comparison purposes, composites are melt-processed in the same manner, to the same shape and sampled from the same area.
2. The sample is ashed in a muffle furnace at 450° C. overnight. Fibers are not embrittled at this temperature.
3. A vacuum filtration flask ˜1500 ml, 60 mm Beuchner funnel with perforated plate and coarse/fast flow filter paper are used for vacuum filtration.
4. With a brush, probe, or tweezers, the outer fibers are separated away from the ash clump. The fibers that were cut are discarded. The remaining sample should be ˜¾″ by ¾″.
5. If large clumps exist, gently separate the clump using probe tips or narrow tweezer tip.
6. 500 ml of water and 40 ml glycerin are stirred in a 1000 ml beaker.
7. Glass fibers are added to the beaker, and the beaker is placed in an ultrasonic bath so that the beaker sits lightly in the bath. The ultrasonic bath is run for 30 seconds and most of the fibers separate. Any remaining clumps can be transferred to a separate dish with added water/glycerin, separated and returned to the beaker sample. A fiber-optic light can be shined into the beaker to confirm suspension and randomization.
8. An 11 mm dia. pipette is plunged into the beaker ˜15 to 20 times until all the fibers are suspended and randomized. Suspension is expelled, the pipette is centered in the beaker and 20 ml. of suspension are drawn in. The suspension is transferred over the funnel and poured in circular motion to spread fibers uniformly over the filter paper.
9. Fibers and funnel wall are rinsed using methanol from a squeeze bottle removing glycerin. Fibers are vacuumed until the filter paper is dry.
10. The funnel is separated and inverted directly over a Petri dish so that the filter paper falls into the Petri dish. Carefully remove the paper so as to not slide in the dish.
11. The paper is snapped taught to dislodge remaining fibers from the filter paper. A soft bristle brush can be used to brush off remaining fibers into the Petri dish.
12. The sample dish should contain randomly aligned fibers and virtually no clumps.
13. If the sample density is too high, the sample can be spread over two dishes and both analyzed. The auto analyzer is run until at least 3000 fibers are imaged.

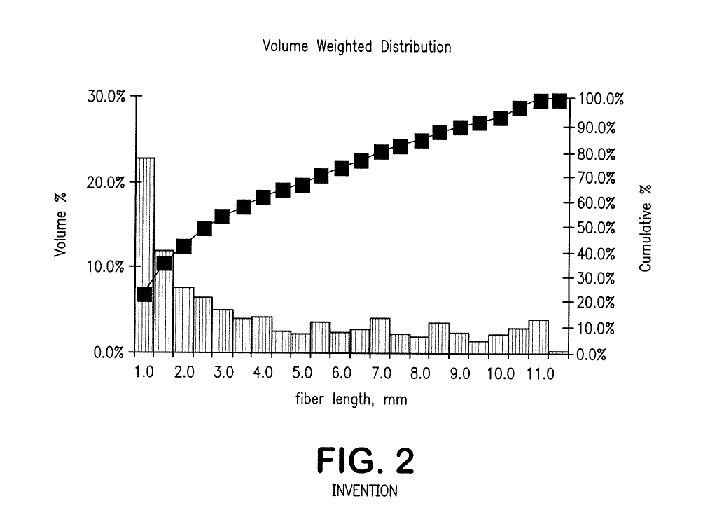

The above method provides calibration in a single frame, and image processing so that a 65×50 mm area can be analyzed. The process enables short and long fibers to be measured with accuracy. The fibers in the prescribed field are automatically imaged and measured so that sampling is unbiased. See FIG. 1 compared to 2. In the PP-LFT molded from 11 mm pellets, FIG. 2 illustrates the invention, where only 55% of fibers are reduced to 3 mm or less, out of the original 11 mm. Whereas FIG. 1 illustrates a conventional PP-LFT of the same PP but without the mixture of amorphous and semi-linear PBT, and 90% of the fibers are 3 mm or shorter. The 45% of fibers greater than 3 mm according to the invention contributes to improved mechanical properties.

Improvement in mechanical properties is inversely proportional to the degree of conversion of the macrocyclic polyester oligomer to a semi-crystalline, linear form. By reducing the level of conversion to the linear form to 50% or less, the improvements are achieved.

### Example 5

### Polycarbonate/Acrylonitrile-Butadiene-Styrene (PCABS)@(40% Glass Fiber

The following example was completed to demonstrate the advantages and benefits of adding the polyester oligomer to a polycarbonate/acrylonitrile-butadiene-styrene polymer.

In this example, the macrocyclic polyester oligomer was combined with a polycarbonate/acrylonitrile-butadiene-styrene polymer in producing fiber-reinforced composite pellets. The resulting material was subjected to various tests. In one set of tests, for instance, the flow length of the material was determined. The flow length of the material measures the distance traveled by the composition in a melt phase. More particularly, the composite material is injection molded into a spiral flow tool at standard conditions. The amount of distance the material travels along the spiral path is measured. Longer distances indicate a material that is more amenable to injection molding processes.

As used herein, the flow length was determined using a single cavity ISO spiral flow mold obtained from Liberty Mold. The spiral flow path had a 140 cm flow distance and is engraved in one centimeter increments. The cross section of the flow path is approximately 0.05 inches deep and 0.10 inches wide in a radius design.

In the first set of experiments, the macrocyclic polyester oligomer was physically blended with preformed polymer composite pellets containing 40% by weight long glass fibers impregnated with 60% by weight polycarbonate/acrylonitrile-butadiene-styrene polymer. The pellets had a length of 11 mm. The acrylonitrile-butadiene-styrene polymer used in this example was FR110 BAY BLEND polymer obtained from the Bayer Corporation.

In the first sample, 3% by weight of the cyclic polyester oligomer was added to the above described composite pellet. The resulting mixture was then injection molded into the spiral flow mold and compared to a control that did not contain the macrocyclic polyester oligomer. In the second sample, 5% by weight of the macrocyclic polyester oligomer was added to the fiber-reinforced composite pellets. The following results were obtained:

| Sample No. | Flow Length (cm) |
|---|---|
| Control | 6.5 |
| Sample No. 1 | 10.8 |
| Sample No. 2 | 17.0 |

As shown above, Sample No. 1 containing 3% by weight of the macrocyclic polyester oligomer increased the flow length by 65%. As shown in Sample No. 2 above, when the polymer contained the macrocyclic polyester oligomer in an amount of 5% by weight, the flow length increased by 161%.

In the next set of experiments, the macrocyclic polyester oligomer was combined with the polycarbonate/acrylonitrile-butadiene-styrene polymer prior to impregnation of the glass fibers. Specifically, the macrocyclic polyester oligomer was combined with the polycarbonate/acrylonitrile-butadiene-styrene polymer via physical blending and then homogenized in the melt phase on a 30 mm twin screw extruder. Glass fibers were then impregnated downstream to produce pellets containing 40% by weight glass fibers, 55% by weight polycarbonate/acrylonitrile-butadiene-styrene polymer, and 5% by weight macrocyclic polyester oligomer.

The resulting fiber-reinforced composite polymer pellets were then injection molded into test specimens that were tested for various physical properties. The pellets were also tested for flow length. The results are shown below under Sample No. 3. For purposes of comparison, a control was also tested that did not contain the macrocyclic polyester oligomer.

| Properties | Method | Units | Control | Sample No. 3 |
|---|---|---|---|---|
| Tensile Strength | ISO 527 | Mpa | 124 | 135 |
| Tensile Modulus | ISO 527 | Mpa | 14029 | 1367 |
| Elongation at Break | ISO 527 | % | 1.05 | 1.10 |
| Flexural Strength | ISO 178 | Mpa | 194 | 221 |
| Flexural Modulus | ISO 178 | Mpa | 13113 | 12973 |
| Notched Impact | ISO 179 | KJ/m² | 13.5 | 15.7 |
| Flow Length | | cm | 6.5 | 11.8 |

As shown above, the presence of the macrocyclic polyester oligomer not only dramatically increased flow length but also improved various other properties.

### Example 6

### Polypropylene@40% Glass Fiber Molded into a Foam

In this example, fiber-reinforced composite pellets containing polypropylene and glass fibers in an amount of 40% by weight were injection molded to form foam specimens. In comparison, similar fiber-reinforced composite pellets that contained polypropylene in combination with 5% by weight of the macrocyclic polyester oligomer were similarly injection molded into a foam to form samples. The specimens were tested for fiber length as described in Example No. 4 above.

In order to produce the foam specimens, the MUCELL Injection Molding System was used that is commercially available from Trexel, Inc. The MUCELL process, for instance, is generally described and disclosed in U.S. Pat. No. 6,884,377 and U.S. Patent Application Publication No. 2005/0042434, which are both incorporated herein by reference.

In a first set of experiments, a molding screw was used in the equipment that had a compression ratio of greater than about 2.5:1. The samples made according to this process are listed as “Control A” and “Sample A” in the table below.

In the second set of experiments, a molding screw was used similar to that shown in FIG. 3. The molding screw had a compression ratio of less than about 2.5:1. The samples produced according to these experiments are listed as “Control B” and “Sample B” in the table below. The following results were obtained:

| | Volume Mean Fiber Length |
|---|---|
| | (mm) |
| Control A | 1.36 |
| Sample A | 1.52 |
| Control B | 1.44 |
| Sample B | 1.48 |

As shown above, the presence of the macrocyclic polyester oligomer produced foam samples having greater fiber lengths.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A fiber-reinforced composite polymer pellet or strand comprising:
reinforcing fibers contained in a polymer composition, the polymer composition comprising a thermoplastic polymer combined with an incompatible polymer resin, the incompatible polymer resin comprising a macrocyclic polyester oligomer and a linear polyester polymer formed from the macrocyclic polyester oligomer.

2. A fiber-reinforced composite polymer pellet or strand as defined in claim 1, wherein the polymer composition comprises from about 80% to about 90% by weight of the thermoplastic polymer and from about 1% to about 20% by weight of the incompatible polymer resin.

3. A fiber-reinforced composite polymer pellet or strand as defined in claim 1, wherein the incompatible polymer resin comprises about 50% by weight or less of the linear polyester polymer.

4. A fiber-reinforced composite polymer pellet or strand as defined in claim 1, wherein the reinforcing fibers are present in the pellet or strand in an amount from about 5% to about 80% by weight.

5. A fiber-reinforced composite polymer pellet or strand as defined in claim 1, wherein the reinforcing fibers are present in the pellet or strand in an amount from about 40% to about 70% by weight.

6. A fiber-reinforced composite polymer pellet or strand as defined in claim 1, wherein the pellet or strand has a length of at least about 3 mm.

7. A fiber-reinforced composite polymer pellet or strand as defined in claim 1, wherein the thermoplastic polymer comprises a polyolefin.

8. A fiber-reinforced composite polymer pellet or strand as defined in claim 1, wherein the thermoplastic polymer comprises an acrylonitrile-butadiene-styrene.

9. A fiber-reinforced composite polymer pellet or strand as defined in claim 8, wherein the thermoplastic polymer further comprises a polycarbonate.

10. A fiber-reinforced composite polymer pellet or strand as defined in claim 1, wherein the reinforcing fibers comprise glass fibers, talc fibers, wollastonite fibers, carbon fibers, metal fibers, aromatic polyamide fibers, or mixtures thereof.

11. A fiber-reinforced composite polymer pellet or strand as defined in claim 1, wherein the linear polyester polymer comprises a polybutylene terephthlate.

12. A fiber-reinforced composite polymer pellet or strand as defined in claim 1, wherein the reinforcing fibers comprise cut fibers and wherein the pellet or strand has a length of from about 3 mm to about 100 mm.

13. A fiber-reinforced composite polymer pellet or strand as defined in claim 1, wherein the pellet or strand further contains at least one additive, the additive comprising an antioxidant, a UV stabilizer, a colormaster batch, or mixtures thereof.

14. A fiber-reinforced composite polymer pellet or strand as defined in claim 1, wherein the pellet or strand has a flow length of greater than about 8 cm.

15. A fiber-reinforced composite polymer pellet or strand as defined in claim 1, wherein the pellet or strand has a flow length of greater than about 10 cm.

16. A molded article made from the fiber-reinforced composite polymer pellet or strand as defined in claim 1.

17. A molded article as defined in claim 16, wherein the polymer composition comprises a foam matrix surrounding the reinforcing fibers.

18. A fiber-reinforced composite polymer pellet or strand as defined in claim 1, wherein the thermoplastic polymer comprises a polyamide.

19. A polymer composite article comprising:
a polymer matrix made from polymer composition comprising a thermoplastic polymer combined with an incompatible polymer resin, the incompatible polymer resin comprising a macrocyclic polyester oligomer and a linear polyester polymer formed from the macrocyclic polyester oligomer; and
reinforcing fibers dispersed in the polymer matrix.

20. A polymer composite article as defined in claim 19, wherein the polymer matrix has a cellular structure.

21. A polymer composite article as defined in claim 19, wherein the thermoplastic polymer contained in the polymer composition comprises a polyolefin, an acrylonitrile-butadiene-styrene polymer, or a polyamide polymer.

22. A pultrusion process for forming impregnating continuous fiber rovings comprising pulling said rovings at a velocity of at least 30 feet per minute, up to 500 feet per minute through a heated impregnation zone, the impregnation occurring within 3 seconds or less within said zone, at a temperature above the melt temperature and below the decomposition temperature of an incompatible resin mixture which is conveyed to the impregnation zone, and wherein the resin mixture comprises 80-99 wt. % of thermoplastic high polymer resin, and 1-20 wt. % of a macrocyclic polyester oligomer incompatible with said high polymer, said fiber velocity is high enough and said impregnation temperature is limited so as to limit the conversion of macrocyclic oligomer to semicrystalline linear form to a range of from 1 to 60%.
